(19) United States
(12) Patent Application Publication
(10) Pub. No.: US 2019/0149887 A1
(43) Pub. Date: May 16, 2019

(54) USER INTERFACES FOR DISPLAYING VIDEO CONTENT STATUS INFORMATION IN A MEDIA PLAYER APPLICATION

(71) Applicant: Philo, Inc., San Francisco, CA (US)

(72) Inventors: Devon Ray WILLIAMS, Berkeley, CA (US); Andrew MCCOLLUM, San Francisco, CA (US); Daniel RINEHART, Somerville, MA (US); Benjamin Avery CHAMBERS, San Francisco, CA (US)

(21) Appl. No.: 15/811,613

(22) Filed: Nov. 13, 2017

(51) Int. Cl. H04N 21/482; H04N 21/431; H04N 21/472; G06F 3/0481

(52) U.S. Cl. CPC H04N 21/4821; H04N 21/4312; H04N 21/47202; G06F 3/0482; H04N 21/4826; G06F 3/04817; H04N 21/47217

(57) ABSTRACT

Techniques and mechanisms are disclosed for generating and causing display of graphical interfaces which include a new interface element used to intuitively display status information related to video content items across many different types of interfaces and across many different types of client electronic devices and associated display screens. The described interface element comprises a circular status icon including a status ring that can be used to display, among other possible information, an airing progress of a video content item and a user's playback progress of a video content item. The circular status icon described herein provides a compact and consistent way to represent multiple types of status information, thereby enabling the same interface element to be used across many different interfaces and display devices in a consistent manner.

### TECHNICAL FIELD

Embodiments relate generally to graphical user interfaces (GUIs) of a media player application used to browse and play video content received from a video content provider via the internet.

### BACKGROUND

Television has long been a leading medium of video content consumption. Traditional television services provided content at specific broadcast times—often referred to as “linear” programming. However, the widespread presence of personal computing devices and the increasing internet connectivity of such devices in recent decades is changing the way many people consume television and other video content. Today, for example, several different service providers offer consumers access to major cable channels, video on demand (VOD) content, and other video content via the internet instead of through traditional broadcast, satellite, and cable systems. The services offered by these service providers, including so-called “over-the-top” (OTT) television service providers, continue to grow in popularity.

Users typically access video content available from such services via the internet using media player applications, which may include a web browser, running on any of a wide-variety of client electronic devices including personal computers, mobile devices, set-top boxes, digital media players, smart TVs, gaming devices, and so forth. For example, an internet-based television service provider might typically create mobile apps that enable users to access the service using one or more types of mobile devices, media player applications for access using personal computing devices, and provide web-based interfaces for access using a web browser. Media player applications might also be developed to run on smart TVs, digital media players, gaming devices, and other devices, providing users with multiple options for accessing content available from the services.

Media player applications for these services generally enable users to browse available content (for example, television programs, movies, sporting events, and other video content) and to select content items for viewing, among other features. For example, a media player application might include an electronic program guide (EPG) interface displaying a continuously updated list of television channels available to a user and a scheduled list of television programs airing on each channel throughout the day. Other interfaces might enable users to view a list of only currently airing content and to play selected content items, including interface elements for playback control (for example, fast forward, rewind, pause, scanning controls, and so forth).

### BRIEF DESCRIPTION OF THE DRAWINGS

Embodiments of the invention may best be understood by referring to the following description and accompanying drawings that are used to illustrate embodiments of the invention. In the drawings:

FIG. 1 illustrates a graphical user interface (GUI) screen or portion thereof displaying an EPG and including a circular status icon overlaying one of the EPG's program listings, according to some embodiments;

FIG. 2 illustrates a GUI screen or portion thereof displaying a circular status icon overlaying a program listing and indicating an associated video content item's airing progress, according to some embodiments;

FIGS. 3A-3B illustrates GUI screens or portions thereof including a “live now” content interface and a program-specific interface, each interface including circular status icons displayed in association with several separate program listings, according to some embodiments;

FIG. 4 illustrates a GUI screen or portion thereof displaying a video playback interface, according to some embodiments;

FIG. 5 illustrates a GUI screen or portion thereof including multiple circular status icons overlaying separate program listings and indicating different types of status information, according to some embodiments;

FIGS. 6A-6B illustrate GUI screens or portions thereof displaying circular status icons overlaying program listings and indicating a user's playback progress, according to some embodiments;

FIGS. 7A-7E illustrate several examples of circular status icons displaying various types of status information, according to some embodiments;

FIGS. 8A-8B are flow diagrams illustrating example processes for displaying circular status icons using a same presentation format, according to some embodiments;

FIG. 9 illustrates a video streaming system, according to some embodiments; and

FIG. 10 illustrates a video streaming system architecture, according to some embodiments.

### DETAILED DESCRIPTION

### 1.0. General Overview

A user of a media player application often takes several pieces of information into consideration when deciding on video content items to watch. When browsing available linear programming options, for example, users might typically be interested in knowing timing-related information such as whether a program has already aired, is currently airing, or will be airing at a time in the future. A user might also be interested in knowing the user's own past viewing history, for example, whether the user has already watched some or all of a program at some time in the past and, if so, how much of a program the user has previously watched. Existing media player applications sometimes represent such information using a variety of graphical and textual interface elements, for example, using time tables in an EPG to indicate airing times and linear progress bars to represent a program's airing progress or user's viewing progress. However, a lack of consistency among such representations makes it difficult for users to quickly evaluate this information and to efficiently select programs of current viewing interest to the user.

According to embodiments described herein, a media player application includes a new interface element that can be used to intuitively display various types of status information related to video content items across many different types of interfaces (for example, across EPG interfaces, “live now” content interfaces, program-specific interfaces, search interfaces, and so forth) and across many different types of client electronic devices and associated display screens (for example, across mobile devices with small touch screen displays to digital media players coupled to big-screen television displays). In one embodiment, the interface element comprises a circular status icon including a status ring that can be used to display, among other possible information, an airing progress of a video content item and a user playback progress of a video content item. In some embodiments, the status ring encircles a symbol reflective of a control such as: 1) a triangle (for example, an equilateral triangle) oriented to reflect the icon commonly used to indicate play in a media player; or 2) two parallel vertical lines to reflect the icon commonly used to indicate pause. Among other benefits, the circular status icon described herein provides a compact and consistent way to represent multiple types of status information thereby enabling the same interface element to be used across many different interfaces and display devices in a consistent manner.

In other aspects, embodiments of the invention encompass a computer apparatus and a computer-readable medium configured to carry out the described embodiments.

### 2.0. Functional Overview

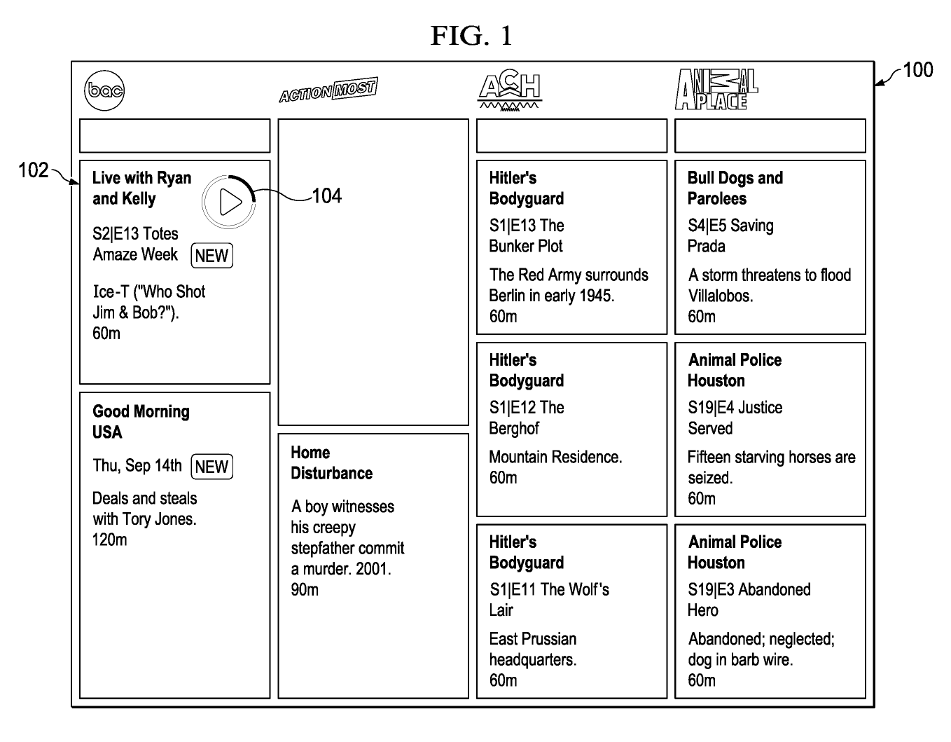

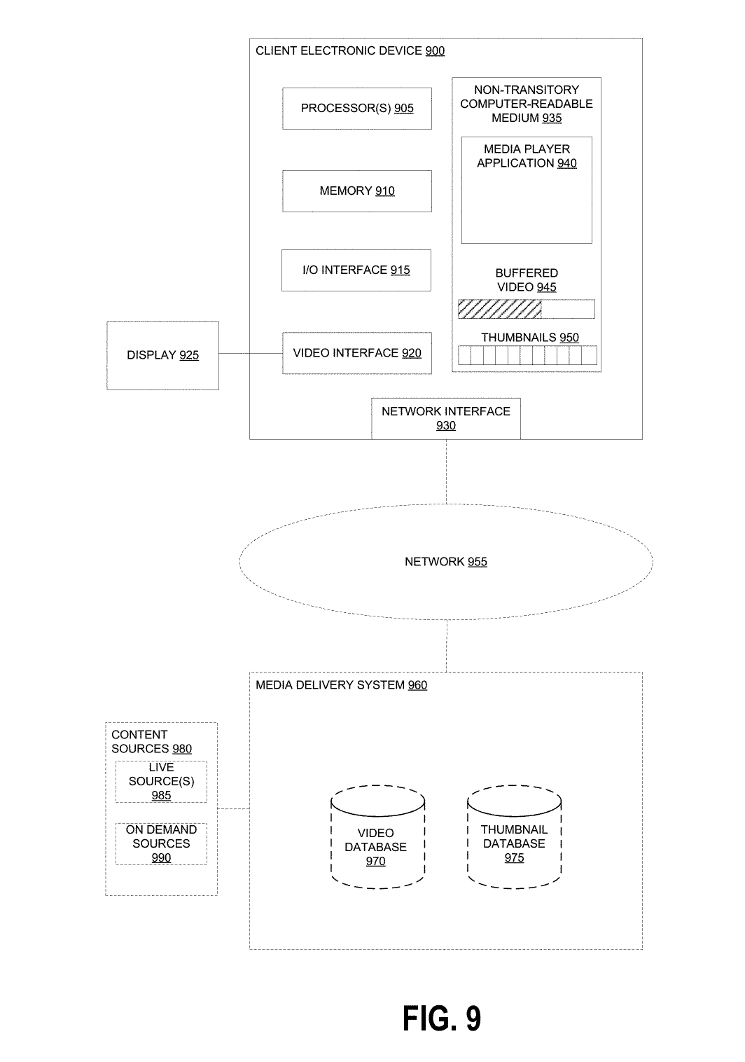

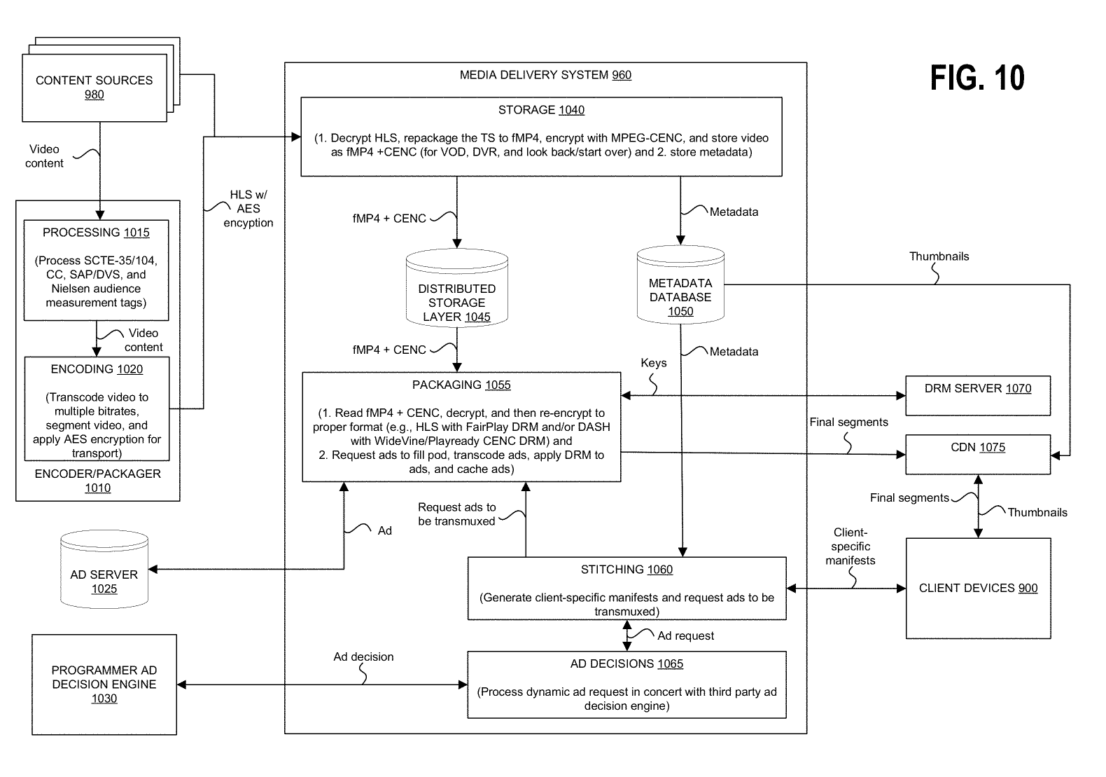

FIGS. 1-7 illustrate multiple GUI interfaces, one or more of which may be displayed by a media player application (which may be a web browser) or other application of a client electronic device. As described in more detail in reference to FIGS. 9 and 10, in some embodiments, such a media player application may be used to access an internet-based television service and can be used to access video content available from such a service.

FIG. 1 illustrates a GUI screen or portion thereof displaying an EPG and including a circular status icon overlaying one of the EPG's program listings. The EPG interface 100 shown in FIG. 1 includes four columns, each corresponding to a separate television channel, and rows of program listings in each column. The displayed television channels, for example, might represent channels available to a user from an internet-based television service provider, as described above. Although the example program listings shown in FIG. 1 correspond to television programs, in general, program listings can be used to represent movies, sporting events, VOD content, or any other type of video content items. Depending on a size of a display screen, a size of an application window associated with the media player application, among other possible factors, an EPG interface 100 (and other interfaces illustrated herein) might occupy an entire display screen of a client electronic device (for example, when displayed in a full-screen mode) or occupy a portion of the display screen (for example, when displayed in a web-browser or a media player application window that occupies less than the entire display screen area). In general, an EPG interface such as interface 100 might display any number of channel columns and program listing rows.

In FIG. 1, the EPG interface 100 arranges program listings according to a time at which each program begins and ends airing. Although not shown in FIG. 1, for example, a vertical timeline might be displayed on the left or right side of the EPG interface 100 to indicate specific times at which the airing of each program begins and ends. In this manner, program listings displayed closer to the top of the interface represent shows airing earlier relative to shows represented by program listings displayed closer to the bottom of the interface (or vice versa). In other examples, an EPG interface might display each channel as a separate row in the interface and display program listings across the columns of the guide or using any other arrangement.

According to an embodiment, a program listing 102 is shown with an overlaid circular status icon 104. In FIG. 1, the program listing 102 represents a television program airing at a time indicated by the position of the listing in the program guide. In this example, the program listing 102 is a box sized to reflect the duration of the program. Within the box an image (or part thereof) is placed that is reflective of the show and that is overlaid with: 1) various information about the program using left justified text, logos, or both (for example, information indicating a television program title, season, episode, episode title, duration, and so forth); and 2) the circular status icon 104 (in the upper right corner) to present information about the airing progress of the program. In particular, the program of the program listing 102 is currently airing, and the circular status icon 104 is displayed having a status ring forming a circumference of the icon and further including a highlighted arc of the status ring indicating the percentage of the currently airing program that has aired relative to a current real-world time (for example, as determined by an internal clock of the device generating the EPG interface 100). Here, the highlighted arc extends approximately one-fourth of the status ring's total circumference to indicate that, at the current time, approximately one-fourth (25%) of the currently airing program has aired. Thus, if a user selects the program listing 102 for viewing and begins watching the program at the currently airing point (also referred to as the live point), the user can expect to start one-fourth (25%) of the way into the program's total airing. In various embodiments, the circular status icon 104 might be displayed in response to receiving user input (for example, in response to input indicating that a user is hovering an input cursor over the program listing 102, input indicating that a user clicked on the program listing 102 using a mouse cursor or other input device, input indicating that a user touched the program listing 102 using a touch screen display, or other input) or can be displayed automatically based on generation of the interface 100 or any other conditions.

The example use of a circular status icon 104 in FIG. 1 is only one example. As described in relation to other example interfaces illustrated herein, the same circular status icon can be used in a variety of other interfaces to present the same and other types of status information using dynamically updating arcs of the same status ring. Accordingly, users can readily obtain multiple types of information related to video content items with reference to a single data presentation format, thereby providing a level of consistency that allows for easier and faster comprehension by users.

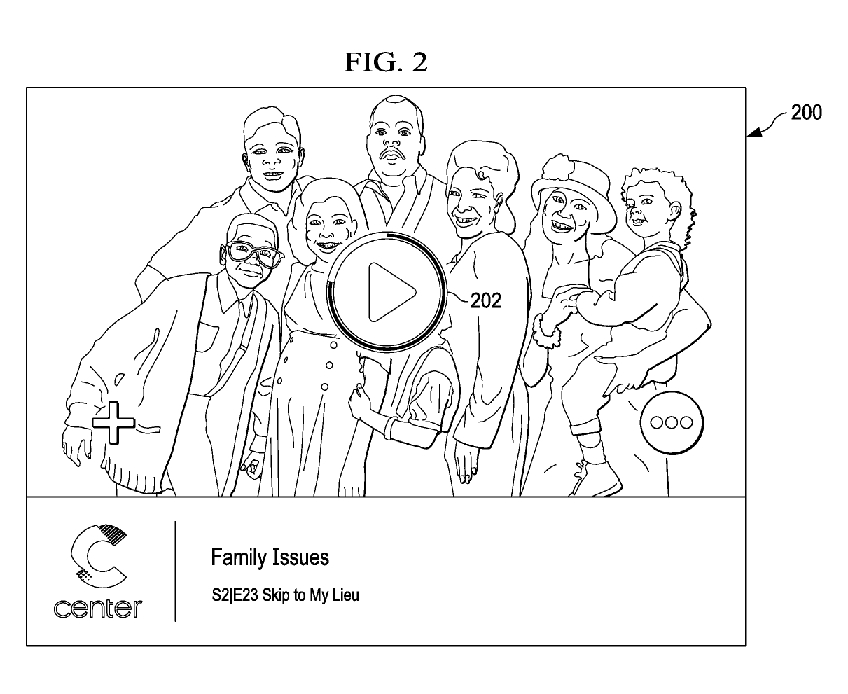

FIG. 2 illustrates a GUI screen or portion thereof displaying a circular status icon overlaying a program listing and indicating an associated video content item's airing progress. The program listing 200, for example, might be displayed as part of a EPG interface or any other interface displaying one or more program listings. As shown, the program listing 200 is a rectangle that is not sized to reflect the duration of the program. The program listing 200 displays various information related to an associated video content item using left justified text and logos, including a television channel, a program title, a season and episode number, an episode title, underneath an image (or part thereof) that is reflective of the program (for example, a thumbnail). In other embodiments, a program listing 200 can include some or all of the following information: a summary of a corresponding television program or movie, a plot summary for a television program episode, and information related to actors, directors, date of release, and so forth. The program listing 200 further includes a circular status icon 202 overlaying the image (generally in its center) and indicating a current airing progress of the associated program. In this example, the highlighted arc of the circular status icon extends approximately three-fourths (75%) of the circumference of the status ring indicating that the program is approximately three-fourths into its airing. Although the circular status icon 202 is overlaid at a different location with respect to the program listing 200 compared to the program guide interface of FIG. 1, the same airing progress information can be readily presented to the user using the same icon. The example of FIG. 2 is particularly useful when displaying a single program listing is being displayed using a larger area of the display than that used for the program listing in the program guide of FIG. 1. For instance, when only a single program listing is display, or when one program listing is displayed using significantly more display area than other program listings also being displayed.

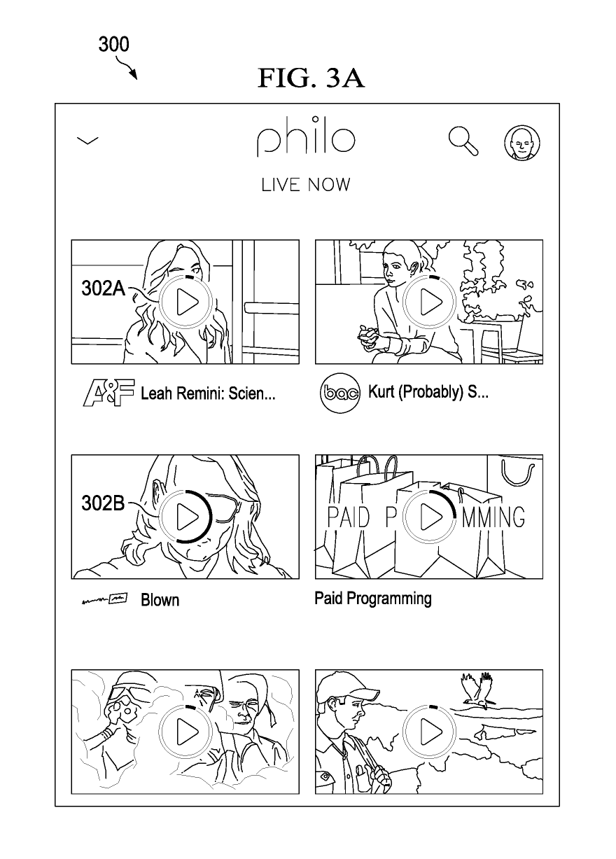

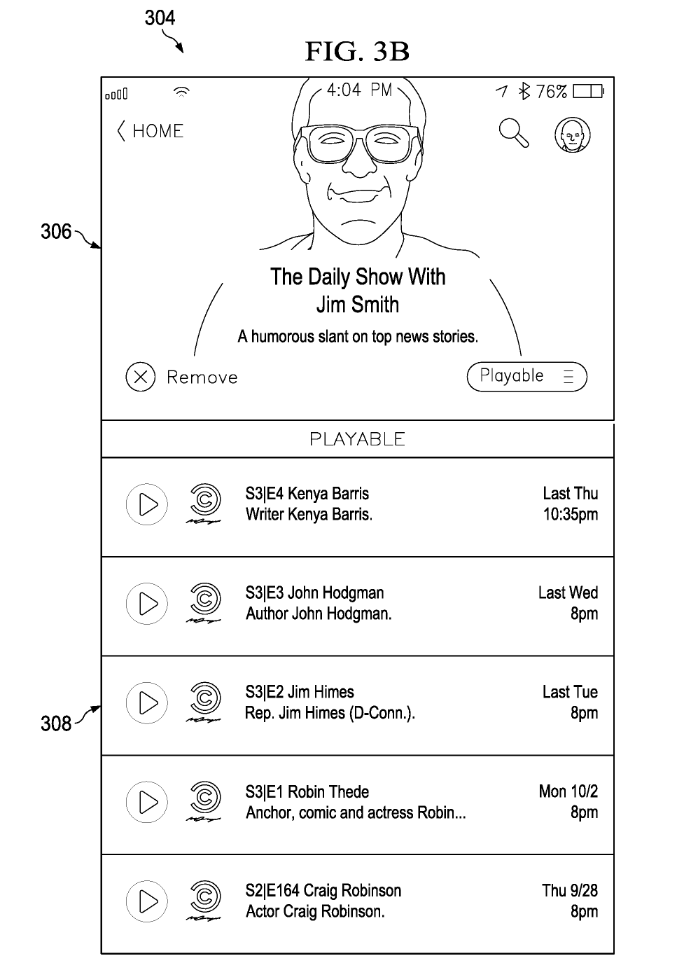

FIGS. 3A-3B illustrate GUI screens or portions thereof including a “live now” content interface and a program-specific interface, each interface including circular status icons displayed in association with several separate program listings. The “live now” content interface 300 shown in FIG. 3A includes a tiled arrangement of program listings, each program listing being same sized and indicating the associated channel and program title underneath an image (or part thereof) that is reflective of the program (for example, a thumbnail). In an embodiment, this “live now” content interface 300 only shows programs that are currently airing; and since a channel airs a single program at a time, it illustrates different channels and the program currently airing on each channel. The example interface 300 of FIG. 3A illustrates that a same circular status icon (for example, circular status icons 302A and 302B) can be used multiple times on a same interface to display information for respective content items. For example, although each of the same sized tiles shown in the “live now” content interface 300 represents a currently airing program, each particular program may be at a different relative point into its airing depending on when the program started airing and a total duration of the program. The circular status icon 302A, for example, includes a highlighted arc indicating that the associated program is only a small portion into its total airing, whereas the circular status icon 302B includes a highlighted arc indicating that its associated program is more than halfway into its total airing). This interface may be particularly useful on smaller displays because it doesn't include a timeline (discussed above relative to FIG. 1) and it does not display information about programs that are not currently airing. Thus, this interface provides a compact format to display multiple currently airing programs using separate tiles and the airing progress information of each program is presented using one of the circular status icons displayed in each tile. This interface may be easier to navigate on smaller display screens as compared to the program guide of FIG. 1.

FIG. 3B illustrates a program-specific interface 304, including a program banner 306 displayed above a list of playable program episodes. As shown, each of the displayed episode listings includes information indicating a channel, season, episode number, episode title, and airing time and further includes a circular status icon displayed on the left side of the episode listing. For example, a circular status icon 308 is displayed on the left side of the first episode listing. In this example, each of the circular status icons shown in the interface 304 includes a status ring with no additional highlighted arcs indicating that the corresponding program is not currently airing (in this case, because each the episode has aired in the past) and that the user has not watched any part of the programs. In other examples, if a user has watched some or all of one or more listed program episodes, the corresponding circular status icon can display a highlighted arc indicating a percentage of the episode watched by the user.

The GUI screens of FIGS. 1-3 can be used in the same media player application, such as: 1) FIG. 1 when the user wants the ability to see what has already aired, is currently airing, and what will air according to the timeline; 2) FIG. 2 when the user wants displayed information about a particular program using a larger part of the display area than that used for each program listing in FIG. 1 (for example, upon a user providing input indicating the selection of a specific program listing in FIG. 1, the display may transition from the GUI of FIG. 1 to the GUI of FIGS. 2); and 3) FIG. 3A when the user wants the ability to see only what is currently airing (for example, upon a user providing input indicating the selection of a specific program listing in FIG. 3A, the display may transition from the GUI of FIG. 3A to the GUI of FIG. 2). Of course, embodiments may implement all of FIGS. 1-3, or only a subset (e.g., just FIGS. 1-2, FIGS. 2-3, FIG. 1, or FIG. 3).

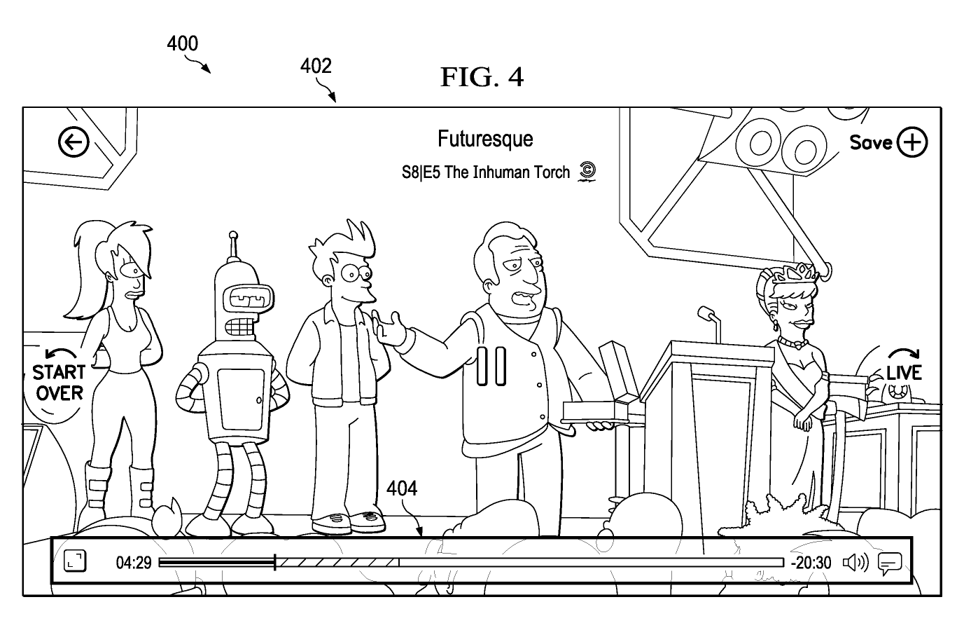

FIG. 4 illustrates GUI screen or portion thereof displaying a video playback interface. As shown, a playback interface 400 includes a content section 402 and playback controls section 404. For example, the playback interface 400 might be displayed in response to a user selecting a program for viewing from an interface (such as FIGS. 1-3) or any other interface. In general, a playback interface 400 enables a user to view and control playback of a video content item. A user can use various interface elements of the playback controls section 404 to fast forward, rewind, pause, or jump to a particular point in time within a video content item (for example, using the linear progress bar indicating a current play point, a total content duration, and other possible information). During playback of the video content item, the user can navigate to other interfaces of the media player application as desired (for example, back to one of the interfaces in FIGS. 1-3 or any other interface).

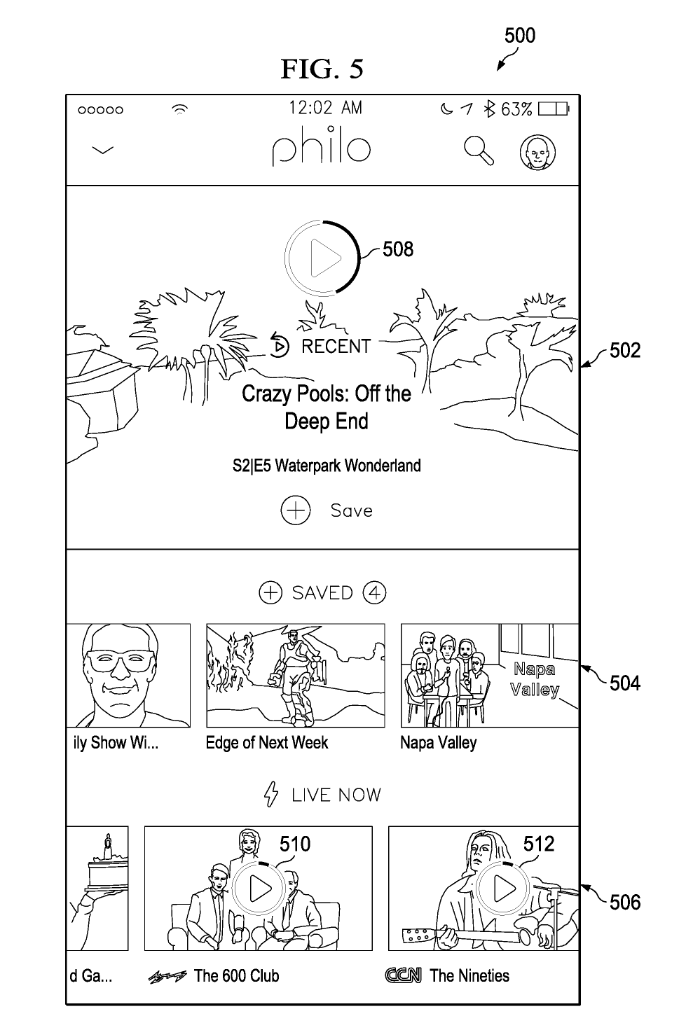

FIG. 5 illustrates a GUI screen or portion thereof including multiple circular status icons overlaying separate program listings and indicating different types of status information. As shown, a home interface 500 of FIG. 5 includes a display of a main program listing 502 (which covers more of the display area than the other program listings), one or more saved program listings 504, and one or more “live now” program listings 506. As shown, a circular status icon 508 overlays the main program listing 502 and shows a user's current playback progress for the program. For example, the user's current playback progress might be shown after a user navigates to the interface 500 from a playback interface as shown in FIG. 4. A second and third circular status icons 510 and 512 are shown overlaying two program listings of the “live now” program listings 506, these circular status icons indicating an airing progress of the associated program listing. As illustrated by FIG. 5, separately displayed circular status icons can be used to present different types of information (for example, the user's current playback progress information and airing progress information) in a same interface.

In FIG. 5, the main program listing 502 is a box that is not sized to reflect the duration of the program, and in that box is placed an image (or part thereof) that is reflective of the show and that is overlaid with: 1) the circular status icon 508 (in the upper center); and 2) underneath various information related to the associated video content item using centered text, logos, or both, including a program title, an episode title, a season and episode number, a channel, and other controls (for example, a circle with a plus inside and next to it the word “Save”). While the main program listing 502 is illustrated in one format, alternative embodiments may use a different format (for example, like that shown for a program listing in any of FIGS. 1-3, or like that shown for a program listing in any of FIGS. 1-3 but with the radial dial reflecting the user's current playback progress information). Additionally or alternatively, while FIG. 5 illustrates each of the “live now” program listings 506 with the same content as the program listings in FIG. 3, alternative embodiments may use a different arrangement (for example, such as that in FIG. 1). Additionally or alternatively, in some embodiments both the saved program listings 504 and “live now” program listing 506 are independently left and right scrollable (for example, inertially scrollable based on swipe gestures on a touch screen display). Additionally or alternatively, while in FIG. 5 the one or more saved program listings are not each overlaid with the circular status icon, alternative embodiments could overlay each of these listing with the circular status icon.

The GUI screens of FIGS. 1-5 can be used in the same media player application, such as: 1) FIG. 5 as the home screen; 2) FIG. 4 during video playback (for example, when the user has provided an input responsive to which a video is selected for playback, such as selecting one of the circular status icons in FIG. 5); 3) FIG. 1 or FIG. 3 (for example, depending on the available area of the display, the size of the display itself, or type of device the media player application is designed for—such as FIG. 1 for larger display and FIG. 3 for a mobile device) when the user has provided an input selecting the “Live Now” text of FIG. 5; and 4) FIG. 2 when the user wants displayed information about a particular program using a larger part of the display area than that used for each program listing in FIGS. 1 and 3 (for example, upon a user providing input indicating the selection of a specific program listing in FIG. 1, FIG. 3, the save program listings 504, or the “live now” program listings 506—such as the user clicking on an area of a program listing other than that occupied by a circular status icon), the display may transition from that GUI to the GUI of FIG. 2; and upon the user providing input indicating playback in FIG. 2, the display may transition from the GUI of FIG. 2 to the GUI of FIG. 4). Of course, embodiments may implement all of FIGS. 1-5, or only a subset (for example, only FIGS. 1-2 and 4; FIGS. 2-3 and 4; FIGS. 2-5; FIGS. 4-5; FIG. 1; or FIG. 3). In other embodiments, other interfaces of a media player application may include interfaces showing program listings organized by category or genre, personalized recommendations based on a user's viewing history, program listings popular with friends, showing only on-demand content items, and search interfaces to locate program listings by name or metadata (for example, keywords, movie or episode play descriptions, and so forth).

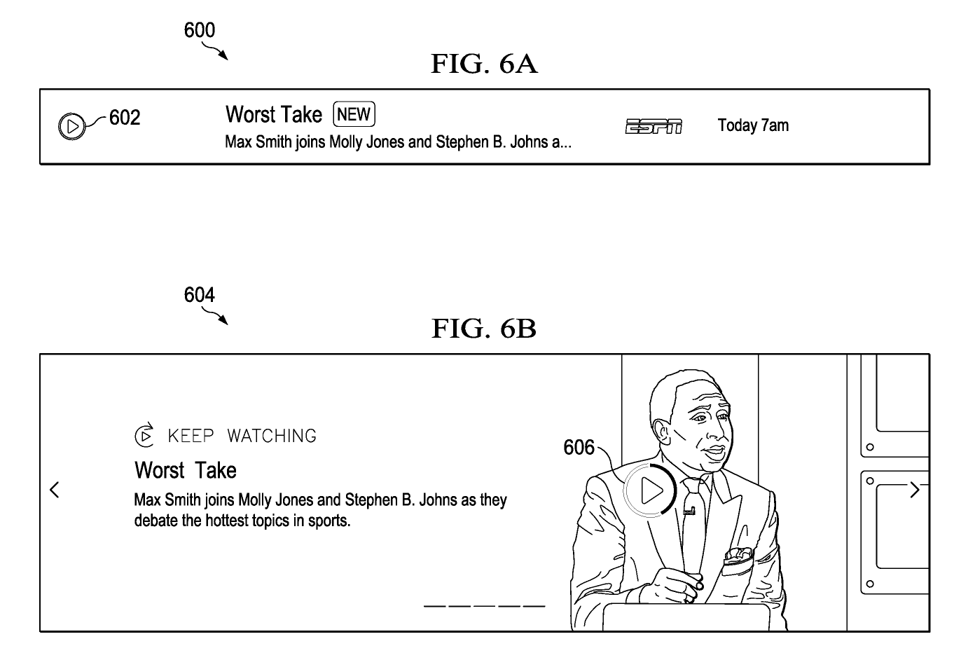

FIGS. 6A-6B illustrate GUI screens or portions thereof displaying circular status icons overlaying program listings and indicating a user's playback progress. For example, the interface portion 600 includes various program listing information using text or icons, or both, (such as a program title, program summary, channel and airing time). As shown, a circular status icon 602 is displayed adjacent to (to the left of) the program listing information, the circular status icon 602 including a highlighted arc indicating a user's playback progress into the associated video content. FIG. 6B illustrates another example of an interface portion 604 including a circular status icon 606. The circular status icon 606 of interface portion 604, for example, is shown overlaying an image (or part thereof) that is reflective of the show, where the image is right justified in a banner and where various information related to the associated video content item is provided using text, logos, or both (such as a program title, an episode title, a season and episode number, a channel, and other controls (for example, a keep watching control) is left justified in the banner. The interface portions 600 and 604 might be displayed, for example, in an EPG-type interface (for example, similar to FIG. 1), as part of a program-specific interface (for example, similar to FIG. 3B), as part of a home interface (for example, similar to FIG. 5), or as part of any other interface.

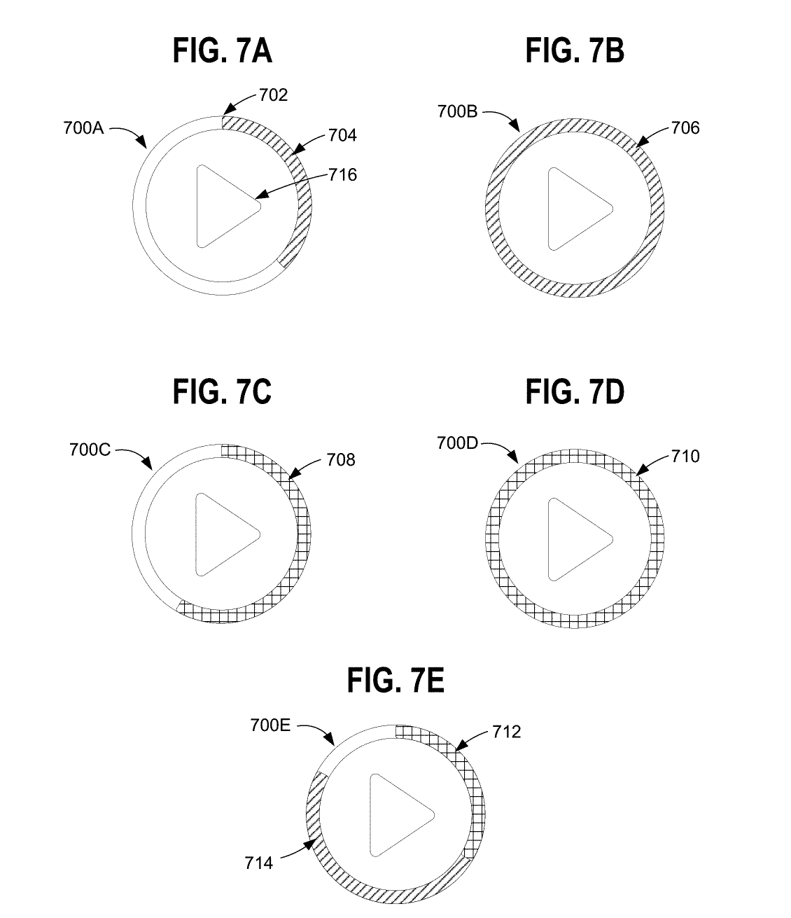

FIGS. 7A-7E illustrate several examples of circular status icons displaying various types of status information. These circular status icons could be used, for example, on any of the GUI interfaces from FIGS. 1-6. In an embodiment, a circular status icon 700A depicts a circular status icon presenting information about the airing progress of a content item. As shown, a point 702 on the circumference of the circular status icon is used to represent the starting point of a video content's airing. Because the status ring extends along the circumference of the status icon, the same point 702 also represents the ending point of the video content's airing. Although the examples illustrated in FIGS. 1-6 and in FIGS. 7A-7E show the start and end at the same point 702, in other embodiments the start and end point can be at different locations on the circumference of the circle such that there is a gap on the status ring between the start and the end points that is relatively small (for example, the gap is 1-25% of the ring, such as the start point at roughly 1 o'clock and the end point at 11 o'clock). Additionally or alternatively, while examples are described herein with the start and the end point at or near the top of the circle, the start and end point(s) generally can be placed anywhere along the circumference of the circle. In an embodiment, the circular status icon 700A includes a playback control icon 716 displayed in the interior of the status ring which can be selected by a user to cause an associated playback action to occur. In this example, the playback control icon 700 is a triangle, representing a play content action, but can be other icons depending on the interface and the state of the associated video content (for example, a pause icon, a replay icon, and so forth).

The circular status icon 700A includes a highlighted arc 704. As indicated above, in this example, the highlighted arc 704 represents airing progress of an associated video content item. However, in other examples, similar highlighted arcs can be used to represent other information about a video content item (for example, an amount of a video content item that is currently buffered in memory, an amount of a video content item that has been recorded, an amount of a video content previously played back by a user, a friend's current play point in a video content item, and so forth).

In an embodiment, the circular status icon 700B includes a highlighted arc 706. In this example, the highlighted arc extends the entire circumference of the circular status icon 700B indicating that the associated video content has aired in its entirety.

In an embodiment, a circular status icon 700C includes a highlighted arc 708 that is shaded differently than the arc shown as part of circular status icons 700A and 700B. In this example, the differently shaded arc 708 might be used to present a different type of status information, for example, information indicating a user's playback progress or a friend's playback progress in a video content item. The circular status icon 700D shows an icon similar to 700C where the differently shaded highlighted arc 710 extends the entire circumference of the icon, for example, indicating that a user has watched an associated program in its entirety.

In an embodiment, a circular status icon 700E illustrates a single icon displaying two separate highlighted arcs 712 and 714. For example, one of the highlighted arcs might indicate a current airing progress of a video content item while the second highlighted arc indicates a user's current playback progress in the same video content item. In general, any two different pieces of information can be represented by separate arcs of a circular status icon and, in embodiments, a circular status icon can include any number of separate arcs to represent multiple pieces of information using a same icon.

Although the example status icons shown in FIGS. 7A-7E and described elsewhere herein refer to circular status icons, in other embodiments, non-linear status icons based on shapes other than circles can be used to efficiently represent multiple types of status information in a similar manner. For example, oval-shaped, triangle-shaped, square-shaped, rectangle-shaped, or other polygon-shaped icons can be used to represent video content status information in a more compact and efficient way compared to existing linear status bars. In each of these alternative examples, a status element forming the non-linear status icon's perimeter can be used to indicate status information in a manner similar to the use of a circular status icon's circumference as described herein. For example, one or more highlighted portions of a non-linear status icon's perimeter (that is, the perimeter of an oval, triangle, square, or other type of shaped icon) can be used to indicate one or more of a portion of a respective video content item that has aired relative to the entire duration of the respective video content, a user's current playback point in a respective video content item, and so forth.

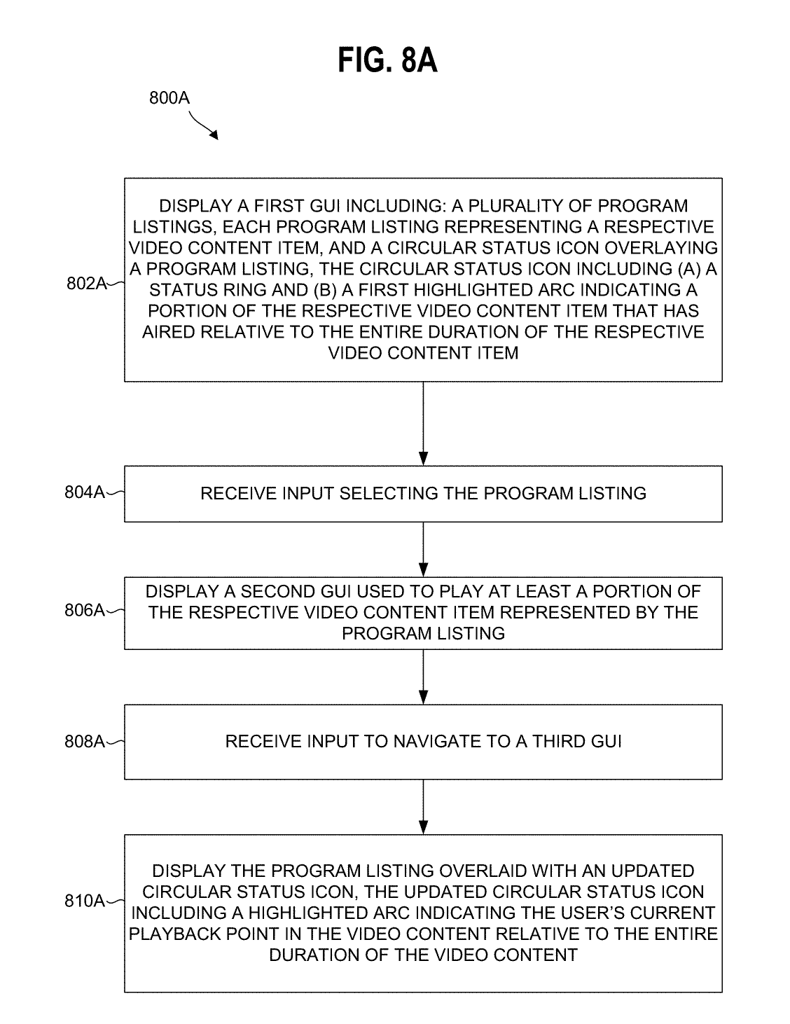

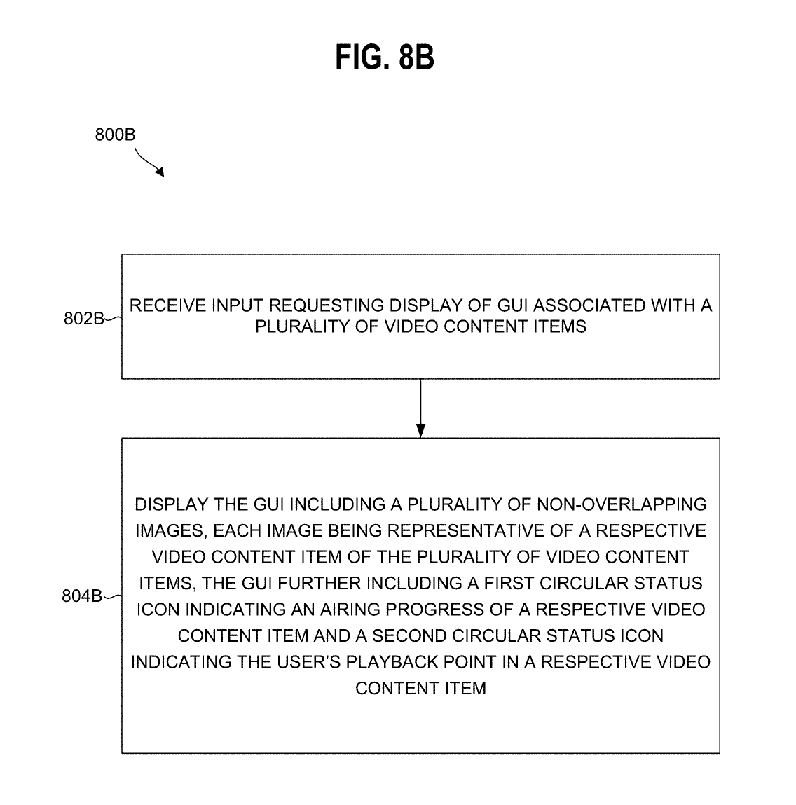

FIG. 8A is a flow diagram illustrating an example process for displaying circular status icons across multiple interfaces to represent different types of status information using a same presentation format. The various elements of flow 800A may be performed in a variety of systems, including systems such as the systems described in reference to FIGS. 9 and 10. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

At block 802A, a media player application displays a first GUI including a plurality of program listings, each program listing representing a respective video content item, and a circular status icon overlaying a program listing of the plurality of program listings, the circular status icon including (a) a status ring forming a circumference of the circular status icon and representing an entire playback duration of the respective video content item represented by the program listing, and (b) a first highlighted arc of the status ring indicating a portion of the respective video content item represented by the program listing that has aired relative to the entire duration of the respective video content item. For example, the first GUI might be an EPG interface 100 or a “live now” interface 300 as shown in FIGS. 1 and 3, respectively, or any other interface displaying one or more program listings. In an embodiment, the first GUI can be displayed in response to receiving user input requesting display of the interface (for example, based on a selection of a menu item or other interface element) or displayed automatically by the media player application (for example, by default in response to the user opening the media player application).

As described in relation to FIG. 1, for example, each of the program listings might include information such as a title of the corresponding video content item, a channel airing the video content item, a thumbnail associated with the video content item, and a text summary of the video content item. If the interface is an EPG interface 100 as shown in FIG. 1, for example, the program listings can include listings representing video content that has aired, video content that is currently airing, and video content that is airing in the future. In other examples, a “live now” content interface such as in FIG. 3A might display only video content that is currently airing. The information can be obtained from programming data generated by an internet-based television service provider or from a third party.

In an embodiment, each of the program listings can represent a television program, a movie, a VOD content item, a recorded content item, or any other video content available for playback. The video content can be made available by one or more internet-based television services or other video content service providers. In other embodiments, the program listings can include audio-only content such as music, radio programs, podcasts, and so forth.

In an embodiment, the first GUI further includes a circular status icon overlaying at least one of the displayed program listings. In an embodiment, the circular status icon includes (a) a status ring forming a circumference of the circular status icon and represents an entire playback duration of video content represented by the program listing, and (b) a first highlighted arc of the status ring indicating a portion of the respective video content represented by the program listing that has aired relative to the entire duration of the respective video content. Referring again to FIG. 1, for example, a circular status icon 104 is shown overlaying the program listing 102 and includes a highlighted arc indicating a portion of the respective video content that has aired relative to the entire duration of the respective video content (in this example, the highlighted arc indicating that approximately one-fourth (25%) of the program has aired). In other embodiments, a circular status icon can be displayed partially overlaying or adjacent to an associated program listing.

In one embodiment, the circular status icon can be displayed in response to receiving user input. For example, a user might hover an input cursor over the program listing, click the program listing, or a user might tap the program listing using a touch screen display. In other examples, circular status icons can be displayed overlaying any visible program listings (for example, as shown in FIG. 3A). As described in reference to FIG. 7, a highlighted arc of a circular status icon can be distinguished from the remainder of the status ring using one or more of: different colors for the status ring and the highlighted arc (for example, a gray status ring and a white arc, a white status ring and a blue arc, or any other combination), different line thicknesses for the status ring and the highlighted arc, and different line shadings for the status ring and the highlighted arc, or any combinations thereof.

At block 804A, input is received selecting the program listing displayed at block 802. For example, referring again to the interface 100 of FIG. 1, a user might select the program listing 102 indicating a desire to watch the associated program, or a program listing might be selected from any other interface.

At block 806A, in response to receiving the input selecting the program listing, the media player application displays a second GUI used to play at least a portion of the video content item represented by the program listing. For example, the media player might generate and display a playback interface 400 as shown in FIG. 4. Using this interface, the user can view as much of the video content item as desired and can further user various playback controls to fast forward, rewind, pause, skip to a point in time, or perform other actions with respect to the video content item.

At block 808A, the media player application receives input to navigate to a third GUI displaying an updated program listing representing the video content item. For example, after the user has viewed some portion of the selected video content item, the user may decide to navigate back to an EPG interface, a home interface, or any other interface of the media player application. Interface 500 in FIG. 5, for example, might be displayed in response to a user navigating from a content playback interface playing the video content item represented by the program listing 502 because the user desires to find another content item to watch or for any other reason.

At block 810A, in response to receiving the input to navigate to the third GUI, the media player displays the updated program listing and an updated circular status icon overlaying the updated program listing. In an embodiment, the updated circular status icon includes a highlighted arc indicating the user's current playback point in the video content relative to the entire duration of the video content. As indicated above, the interface 500 includes a program listing 502, which might be displayed after a user has viewed some portion of the video content represented by the listing 502, and further includes an overlaid circular status icon 508 indicating a user's current playback point in the video content. In this manner, the updated listing 502 and circular status icon 508 display different information (for example, the user's playback progress) than that previously showing for the same video content in an earlier interface (for example, the airing progress of the content) but present the information using a same visual format.

FIG. 8B is a flow diagram illustrating an example process for displaying circular status icons representing different status information on a same GUI.

At block 802B, a media player application receives input requesting display of a GUI associated with a plurality of video content items. For example, the GUI might include an EPG interface (as shown in FIG. 1), a “live now” interface (as shown in FIG. 3), or any other interface displaying multiple program listings and associated circular status icons.

At block 804B, in response to receiving the input, displaying the GUI including a plurality of non-overlapping images, each image being representative of a respective video content item of the plurality of video content items. The GUI further includes a first circular status icon overlaying a first image of the plurality of images, the first circular status icon including (a) a status ring forming a circumference of the first circular status icon and representing an entire playback duration of the respective video content item represented by the first image, and (b) a first highlighted arc of the status ring indicating a portion of the respective video content item represented by the first image that has aired relative to the entire duration of the respective video content item. The GUI further includes a second circular status icon overlaying a second image of the plurality of images, the second circular status icon including (a) a status ring forming a circumference of the second circular status icon and representing an entire playback duration of the respective video content item represented by the second image, and (b) a highlighted arc of the status ring indicating the user's playback point in the respective video content item relative to the entire duration of the respective video content item. In an embodiment, the first and second circular status icons look the same except that their respective highlighted arcs are different colors to represent different information about their respective video content items, wherein the respective video content item represented by the first image is currently airing and the user has not watch any part of it, and at least part of the respective video content item represented by the second image has been watched by the user. For example, as shown in FIG. 5, an interface 500 can include multiple circular status icons each indicating a different type of information, such as circular status icon 508 indicating a user's playback progress in the video content item corresponding to the program listing 502 and circular status icons 510 and 512 and indicating an airing progress of the corresponding video content items with which those icons are displayed.

As illustrated by the embodiments described above, a circular status icon can be displayed in one of several modes depending on a state of a respective video content item: (1) when the respective video content item is currently airing but the user has not played any of the item, the circular status icon can be displayed in a first mode having a highlighted arc indicating an airing progress of the item (for example, similar to the circular status icon 104 displayed in FIG. 1); (2) when the respective video content item is currently airing and the user has played back at least part of the video content item, the circular status icon can be displayed in a second mode having a highlighted arc indicating the user's playback progress (for example, similar to circular status icon 508 in FIG. 5); (3) when the respective video content item is not currently airing and the user has not played any of the item, the circular status icon can be displayed in a third mode where there is no highlighted arc displayed (for example, similar to the circular status icon 308 displayed in FIG. 3); (4) when the respective video content item is not currently airing and the user has played back at least part of the video content, the circular status icon can be displayed in a fourth mode having a highlighted arc indicating the user's playback progress (and which may be displayed using a color, shading, or other graphical representation that is different from a highlighted arc representing a video content item's airing progress); and (5) when the respective video content item is not currently airing and the user has played back the video content item in its entirety, the circular status icon can include a highlighted arc that extends the entire circumference of the circular status icon.

### 3.0. Operating Environment—Hardware Overview

According to one embodiment, the techniques described herein are implemented by one or more special-purpose computing devices. The special-purpose computing devices may be desktop computer systems, portable computer systems, handheld devices, networking devices, or any other device that incorporates hard-wired or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, or FPGAs with custom programming to accomplish the techniques.

FIG. 9 is a block diagram illustrating a video streaming system, according to some embodiments. The system includes a client electronic device 900 that is communicatively coupled to a media delivery system 960 over a network 955. In an embodiment, a client electronic device 900 is an electronic device that is able to request video content from the media delivery system 960 and to play video content served by the media delivery system 960. The media delivery system 960 is a remote service configured to receive requests for video content from the client electronic device 900 and to serve the requested video content to the client electronic device 900. Although one client electronic device 900 is shown in FIG. 9, the system can include more than one client electronic device 900 and typically may include many separate client electronic devices 900. Furthermore, the media delivery system can include additional components such as processors, storage servers, authentication servers, firewalls, and load balancers, which are not shown here for sake of clarity.

As shown in the diagram, the client electronic device 900 includes one or more processors 905, a memory 910, an input/output (I/O) interface 915, a video interface 920, a network interface 930, and a non-transitory computer-readable medium 935. The processors 905 may be, for example, general purpose microprocessors. The memory 910 may be a Random Access Memory (RAM) or other dynamic or volatile storage device for storing data and instructions to be executed by the processors 905. Memory 910 may also be used for storing temporary variables or other intermediate information during execution of instructions to be executed by the processors 905. Such instructions, when stored in the non-transitory computer-readable medium 935, render client electronic device 900 to be a special-purpose machine that is customized to perform the operations specified by the instructions.

In one embodiment, the non-transitory computer-readable medium 935 includes a media player application 940. The media player application 940 includes code/instructions, that when executed by the processors 905, cause the client electronic device 900 to perform operations of one or more embodiments described herein related to displaying various GUIs allowing users to browse and play video content accessible from one or more media delivery system 960.

The I/O interface 915 is configured to receive user input from a user via an input device. The input device may be any type of device that can receive user input such as a keyboard, a mouse, a touchscreen panel affixed to a display, a trackpad, or a remote control. Other examples of suitable input devices include cameras, microphones, accelerometers, motion detectors, brain-machine interfaces, and/or other sensors.

The video interface 920 is communicatively coupled to a display 925 and is configured to output video to the display 925. The display 925 may be any type of device that can display video content, the possible types of displays including, but not limited to, a television, a computer monitor, or a touchscreen display. While the display 925 is shown as being separate from the client electronic device 900, in some embodiments, the display 925 is integrated with the client electronic device 900.

The client electronic device 900 may be any type of device that can request and receive video content and can output video content to a display 925. For example, a client electronic device 900 can comprise a mobile device, a tablet computer, a desktop computer, a set-top box (STB), a smart TV, a video game console, a digital media player, a digital versatile disk (DVD) player, or a Blu-Ray player.

The data network 955 can be any type of network capable of transporting data from one device to another device (for example, from a client electronic device 900 to media delivery system 960 and from media delivery system 960 to one or more client electronic devices 900). For example, the data network 955 can include any combination of the internet, a Wide Area Network (WAN), a Local Area Network (LAN), a cellular communications network, a telephone network, a terrestrial analog or digital signal system, a cable system, and a satellite communications system.

The media delivery system 960 includes a video database 970 and a thumbnail database 975. In an embodiment, the media delivery system 960 can be implemented across any number of hardware devices and platforms in a distributed manner. In an embodiment, the media delivery system 960 ingests video content from content sources 980, such as one or more live content source(s) 985 (for example, live linear programming from one or more broadcast sources), one or more on demand content source(s) 990 (for example, one or more VOD content services), or both, and stores some or all of the ingested video content in the video database 970 to be served to client electronic devices 900. The media delivery system 960 may store thumbnails for some or all of the ingested video content in a thumbnail database 975. For example, video content items (for example, television episodes, movies, VOD programs, and so forth) stored in the video database 970 may be associated with corresponding sets of thumbnails. In an embodiment, the set of thumbnails associated with a video content item can include thumbnails each associated with a particular time position in the video. For example, the set of thumbnails for a particular video content item might include a thumbnail for every five second increment in the video. More granular or less granular thumbnail increments are also possible.

In an embodiment, certain components of the media delivery system 960 can be implemented in full or in part using “cloud”-based components that are coupled to the systems by one or more networks, such as the internet. The cloud-based components may expose interfaces by which they provide processing, storage, software, and/or other resources to other components of the systems. In an embodiment, the cloud-based components may be implemented by third-party entities on behalf of another entity for whom the components are deployed. In other embodiments, the described systems may be implemented entirely by computer systems owned and operated by a single entity.

During operation of the system, a client electronic device 900 may generate and transmit requests to the media delivery system 960 to play particular video content items. In response to receiving such requests, the media delivery system 960 may serve the requested video content items to the client electronic devices 900. This may involve transmitting video stored in the video database 970, as well as thumbnails associated with the video stored in the thumbnail database 975, to the client electronic devices 900 over the network 955. The client electronic devices 900 may buffer a portion of the received video content in the non-transitory machine-readable medium 935 and output the buffered video 945 to the display 925. The client electronic device 900 may also store some or all of the thumbnails 950 for the video 945 in the non-transitory machine-readable medium 935. The thumbnails 950 may be used to generate and display a GUI that allows a user to navigate a video 945. Also, the thumbnails 950 may be used to display a transition from a seek operation within a video 945 to playing the video 945, according to embodiments described herein.

While the client electronic device 900 is shown in the context of an internet-based video content service, in other embodiments, the client electronic device 900 can perform operations of one or more embodiments described herein in a context where the video is not streamed from a media delivery system 960. For example, in some embodiments, the video 945 and thumbnails 950 may be downloaded from another content source, copied from a removable storage device, or otherwise accessed by the client electronic device 900 without having to interact with the media delivery system 960.

FIG. 10 is a block diagram illustrating a video streaming system architecture, according to some embodiments. In an embodiment, the system of FIG. 10 includes content sources 980, an encoder/packager 1010, a media delivery system 960, an ad server 1025, a programmer ad decision engine 1030, a Digital Rights Management (DRM) server 1070, a Content Distribution Network (CDN) 1075, and client electronic devices 900. The encoder/packager 1010 includes a processing component 1015 and an encoding component 1020. The media delivery system 960 includes a storage component 1040, a packaging component 1055, a stitching component 1060, and an ad decisions component 1065.

The content sources 980 generate video content that is to be consumed by users. The video content can include live content, VOD content, and any other type of video content.

The encoder/packager 1010 ingests video content from the content sources 980. For example, the encoder/packager 1010 can ingest live content picked up from a signal of a live linear cable network—national or local, where appropriate and agreed upon. As another example, the encoder/packager 1010 can ingest VOD content directly from the programmer itself or via a content aggregation partner. In one embodiment, the encoder/packager 1010 may ingest content via satellite or terrestrial means. In one embodiment, the encoder/packager 1010 receives Society of Cable and Telecommunications Engineers 35 2013 (SCTE-35) markers in a data Program Information Description (PID) along with the video content. SCTE-35 can be used to signal ad insertion opportunities in the transport stream, which can be used for Dynamic Ad Insertion (DAI). In one embodiment, the encoder/packager 1010 receives Nielsen audience measurement tags in a data PID, or embedded in the audio stream. The Nielsen audience measurement tags can be used to measure audience size and demographic information. The processing component 1015 of the encoder/packager 1010 processes the SCTE-35 markers and the Nielsen audience measurement tags as well as any Closed Captioning (CC) and Second Audio Programming (SAP)/Descriptive Video Service (DVS) information.

In one embodiment, the encoding component 1020 of the encoder/packager 1010 transcodes the video content into multiple bitrates (for example, into several Adaptive Bitrate (ABR) profiles) and places key frames at ad boundaries as informed by the SCTE-35 data. The packager segments the content according to the keyframes placed by the transcoder and encrypts the content for transport (for example, using Advanced Encryption Standard (AES) encryption). In one embodiment, the video is packaged using the Hypertext Transfer Protocol (HTTP) Live Streaming (HLS) protocol with AES encryption and the HLS-encoded video is provided to the media delivery system 960 (for example, over a private network connection).

In one embodiment, the storage component 1040 of the media delivery system 960 stores the encoded and encrypted video, decrypts the video, repackages the video to an intermediate format (for example, using fragmented MPEG-4 (fMP4) or any other video streaming format), encrypts the repackaged video (for example, using MPEG Common Encryption (MPEG-CENC)), and stores the encrypted video segments in a distributed storage layer 1045, which serves as the origin for the content distribution network (CDN). In general, the storage component 1040 can store the video in any intermediate file format suitable for transfer to a CDN, directly to client devices, or both. In one embodiment, to provide low-latency access to live content, the media delivery system can act as a fall back origin for the CDN in case the video segments are requested before they have been permanently stored in the distributed storage layer. When a client electronic device 900 requests a video, the video segments can be repackaged on the fly (just-in-time repackaging) into the appropriate output format. In other embodiments, the video content ingested from content sources 980 can be stored in its original format (e.g., HLS) without conversion.

In one embodiment, the distributed storage layer 1045 is provided using a cloud-based storage service. Also, the storage component 1040 may store relevant metadata for the video (for example, timestamps and SCTE-35 markers) in a metadata database 1050 (for example, a relational database or other data storage application). In one embodiment, the metadata includes some or all of: information related to ad positions, ad insertion information, thumbnail image files (for example, stored in JPG or PNG format), and information related to the thumbnails such as their associated time positions in the video. For live video, the metadata may include GIF preview animations showing the most recent video (the most recent 15 seconds, for example). In one embodiment, the thumbnails are cached in one or more Content Distribution Networks (CDNs) to be served to clients.

In one embodiment, the media delivery system 960 ingests mezzanine VOD assets from a programmer via a secure Internet Protocol (IP) connection. The VOD assets may then be processed using a job-based workflow. In one embodiment, the metadata for the VOD assets are ingested and stored in the metadata database 1050 while the mezzanine files are transcoded (for example, to fMP4 with CENC) and stored in the distributed storage layer 1045.

The packaging component 1055 of the media delivery system 960 reads the encrypted video segments, decrypts the segments, optionally transmuxes the segments, and then re-encrypts the segments to the proper format. In one embodiment, the re-encrypted formats include HLS with FairPlay Digital Rights Management (DRM), Dynamic Adaptive Streaming over HTTP (DASH) with WideVine/PlayReady CENC DRM, or both. The packaging component 1055 passes through any ID3 tags for Nielsen measurements and communicates with the DRM server 1070 (which manages content license keys) to ensure that all content is encrypted with up-to-date keys. The final video segments are cached in one or more CDNs 1075 to be served to client electronic devices 900.

The stitching component 1060 of the media delivery system 960 generates client-specific manifests on the fly (just-in-time manifest creation) to allow for fine-grained control over the video stream and the end-user experience. The stitching component 1060 can generate manifests for HLS, DASH, or any manifest format suitable for the client electronic devices 900. The manifests may be generated based on the metadata stored in the metadata database 1050. Also, the stitching component 1060 may drive dynamic ad insertion (DAI) using a programmer ad decision engine 1030. For example, the stitching component 1060 may send a request to the ad decisions component 1065 for ads to be transmuxed into a video. The ad decisions component 1065 processes the dynamic ad request in concert with a third-party ad decision engine such as the programmer ad decision engine 1030 and provides an indication of the ads to be transmuxed into the video. The stitching component 1060 may then make a request to the packaging component 1055 to transmux the ads. When a client ad pod is upcoming, the packaging component 1055 of the media delivery system 960 may request the ads from the ad server 1025 to fill the ad pod, transcode the ads, apply DRM to the ads (because some platforms cannot play encrypted content followed by unencrypted content), and cache the ads. The stitching component 1060 serves the manifest that refers to the freshly transcoded ad pod video segments.

In an embodiment, client electronic devices 900 include a media player application (for example, a media player application 940) capable of playing streaming video (for example, video in HLS with FairPlay format or DASH with WideVine/CENC format). When the user selects a video to watch, the client electronic device 900 requests a manifest for the selected video from the stitching component 1060. In one embodiment, this request is made over HTTP Secure (HTTPS). If the user is not currently streaming more concurrent streams than they are allowed (for example, as determined by the stitching component 1060 or another component of the media delivery system 960), then the stitching component 1060 generates a manifest that is specific for the client electronic device and sends the manifest to the client electronic device 900. The client electronic device 900 may then begin fetching encrypted video segments from the CDN 1075 according to the manifest. In one embodiment, the encrypted video segments are fetched from the CDN 1075 over HTTPS. The content can be fetched from the CDN 1075 over a public network such as the internet and thus may travel across a variety of networks.

The internet-based video content service shown in FIG. 10 may report audience measurement data to Nielsen (or other entities that gather audience measurement data) based on metadata embedded in the video segments. Client electronic devices 900 may have access to a Nielsen Software Development Kit (SDK) library that enables the client electronic devices 900 to report audience measurement data or to implement similar functionality.

In one embodiment, the internet-based video content service shown in FIG. 10 supports the ability to enforce content viewing rules and restrictions according to agreements made with content programmers. For example, these content viewing rules and restrictions may include supporting content blackouts (based on location or device) or content substitutions. In one embodiment, the internet-based video content service periodically pulls blackout information from programmers (for example, via agreed upon methods and timeframes). Additionally or alternatively, in one embodiment, the video streaming platform allows programmers to push blackout updates to the video content service through a cloud-hosted and secure Representational State Transfer (REST) Application Programming Interface (API) (for example, that adheres to SCTE-224). In one embodiment, the video streaming platform can accept blackout information in-band via SCTE-35. In one embodiment, blackout information can include information indicating one or more channels to be blacked out, a zip code to be blacked out, device type(s) to be blacked out, a time period for the blackout, or any combination thereof. The backend of the video content service may integrate with a geofencing library that maps client IP addresses to zip codes, which allows the video streaming platform to prevent or stop playback of video content as needed. This process may integrate with the stitching component 1060 or another component of the media delivery system 960 so that custom slates can be inserted during blackouts as needed. In one embodiment, blackouts are instead indicated as part of program guide data or other metadata provided to the client electronic device 900, for example, via a separate API, allowing the client electronic device 900 to prevent playback of a blacked-out program.

The division of functionality between the various system components shown in FIG. 10 is purely exemplary and is not intended to be limiting. Functions performed by a single system component may instead be performed by multiple system components and functions performed by multiple system components may instead be performed by a single system component.

### 4.0. Example Embodiments

Examples of some embodiments are represented, without limitation, in the following clauses:

One embodiment includes a method comprising: displaying a first graphical user interface (GUI) including: a plurality of program listings, each program listing representing a respective video content item, and a circular status icon overlaying a program listing of the plurality of program listings, the circular status icon including (a) a status ring forming a circumference of the circular status icon and representing an entire playback duration of the respective video content item represented by the program listing, and (b) a first highlighted arc of the status ring indicating a portion of the respective video content item represented by the program listing that has aired relative to the entire duration of the respective video content item; receiving input selecting the program listing; in response to receiving the input selecting the program listing, displaying a second GUI used to play at least a portion of the respective video content item represented by the program listing; receiving input to navigate to a third GUI; and in response to receiving the input to navigate to the third GUI, displaying the program listing overlaid with an updated circular status icon, the updated circular status icon including a second highlighted arc indicating the user's current playback point in the video content relative to the entire duration of the video content.

One embodiment comprises the method above wherein the first GUI is one of: an electronic program guide (EPG) interface, a “live now” content interface, a home interface.

One embodiment comprises the method above wherein the first GUI, the second GUI, and the third GUI are separate interfaces of a media player application.

One embodiment comprises the method above wherein each program listing representing the respective video content item available for playback by the user includes one or more of: a title of the respective video content item, a thumbnail associated with the respective video content item, a channel airing the respective video content item, and a summary of the respective video content item.

One embodiment comprises the method above wherein the program listings include video content that has aired, video content that is currently airing, and video content that is airing in the future.

One embodiment comprises the method above wherein the program listings include only video content that is currently airing.

One embodiment comprises the method above wherein the video content item is one of: a television program, a movie, and a video on demand (VOD) content item.

One embodiment comprises the method above wherein the video content is accessible from an internet-based television service.

One embodiment comprises the method above wherein the circular status icon is displayed in response to receiving input indicating an input device hovering over the program listing.

One embodiment comprises the method above wherein each program listing of the program listings includes a respective circular status icon overlaying the program listing.

One embodiment comprises the method above wherein the entire duration of the respective video content is determined based on programming data indicating timing information for a plurality of video content items.

One embodiment comprises the method above wherein the first highlighted arc is distinguished from the remainder of the status ring using one or more of: different colors for the status ring and the first highlighted arc, different line thicknesses for the status ring and the first highlighted arc, different line shadings for the status ring and the first highlighted arc.

One embodiment comprises the method above wherein the circular status icon displays both the first highlighted arc and the second highlighted arc.

One embodiment comprises the method above wherein the circular status icon displays the second highlighted arc and does not display the first highlighted arc.

One embodiment comprises the method above wherein the third GUI includes at least one program listing overlaid with a circular status icon indicating an airing progress of respective video content and at least one program listing overlaid with a circular status icon indicating a user's playback progress of respective video content.

One embodiment comprises the method above wherein the status ring encircles an icon reflective of a play status.

One embodiment includes a method comprising: receiving input requesting display of a graphical user interface (GUI) associated with a plurality of video content items; and in response to receiving the input, displaying the GUI including: a plurality of non-overlapping images, each image being representative of a respective video content item of the plurality of video content items, a first circular status icon overlaying a first image of the plurality of images, the first circular status icon including (a) a status ring forming a circumference of the first circular status icon and representing an entire playback duration of the respective video content item represented by the first image, and (b) a first highlighted arc of the status ring indicating a portion of the respective video content item represented by the first image that has aired relative to the entire duration of the respective video content item, a second circular status icon overlaying a second image of the plurality of images, the second circular status icon including (a) a status ring forming a circumference of the second circular status icon and representing an entire playback duration of the respective video content item represented by the second image, and (b) a highlighted arc of the status ring indicating the user's playback point in the respective video content item relative to the entire duration of the respective video content item, and wherein the first and second circular status icons look the same except that their respective highlighted arcs are different colors to represent different information about their respective video content items, wherein the respective video content item represented by the first image is currently airing and the user has not watch any part of it, and wherein at least part of the respective video content item represented by the second image has been watched by the user.

One embodiment comprises the method above wherein the GUI further comprises a third circular status icon overlaying a third image of the plurality of images, the third circular status icon including a status ring forming a circumference of the third circular status icon, the third circular status icon displayed without a highlighted arc to indicate that the respective video content item is not currently airing and no part thereof has been watched by the user.

One embodiment includes a device comprising: one or more processors; an input/output (I/O) interface to receive user input; and a non-transitory computer-readable medium having stored therein instructions which, when executed by the one or more processors, causes the device to: display a first graphical user interface (GUI) including: a plurality of program listings, each program listing representing a respective video content item available for playback by a user, and display a circular non-linear status icon overlaying a program listing of the plurality of program listings, the circular non-linear status icon including (a) a status ring element forming a circumference perimeter of the circular non-linear status icon and representing an entire playback duration of video content represented by the program listing, and (b) a first highlighted arc portion of the status ring element indicating a portion of the respective video content represented by the program listing that has aired relative to the entire duration of the respective video content; receive input selecting the program listing; in response to receiving the input selecting the program listing, display a second GUI used to play at least a portion of the video content item represented by the program listing; receive input to navigate to a third GUI displaying an updated program listing representing the video content item; and in response to receiving the input to navigate to the third GUI, display the updated program listing and an updated circular non-linear status icon overlaying the updated program listing, the updated circular non-linear status icon including a second highlighted arc portion indicating the user's current playback point in the video content relative to the entire duration of the video content.

One embodiment includes a non-transitory computer-readable medium having stored therein instructions which, when executed by one or more processors of a computing device, causes the computing device to perform operations comprising: displaying a first graphical user interface (GUI) including: a plurality of program listings, each program listing representing a respective video content item available for playback by a user, and displaying a circular status icon overlaying a program listing of the plurality of program listings, the circular status icon including (a) a status ring forming a circumference of the circular status icon and representing an entire playback duration of video content represented by the program listing, and (b) a first highlighted arc of the status ring indicating a portion of the respective video content represented by the program listing that has aired relative to the entire duration of the respective video content; receiving input selecting the program listing; in response to receiving the input selecting the program listing, displaying a second GUI used to play at least a portion of the video content item represented by the program listing; receiving input to navigate to a third GUI displaying an updated program listing representing the video content item; and in response to receiving the input to navigate to the third GUI, displaying the updated program listing and an updated circular status icon overlaying the updated program listing, the updated circular status icon including a second highlighted arc indicating the user's current playback point in the video content relative to the entire duration of the video content.

### 5.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A computer-implemented method, comprising:
displaying a first graphical user interface (GUI) including:
a plurality of program listings, each program listing representing a respective video content item, and
a circular status icon for a program listing of the plurality of program listings, the circular status icon including (a) a status ring forming a circumference of the circular status icon and representing an entire playback duration of the respective video content item represented by the program listing, and (b) a first highlighted arc of the status ring indicating a portion of the respective video content item represented by the program listing that has aired relative to the entire duration of the respective video content item, the circular status icon displayed to the right of text associated with the program listing;
receiving input selecting the program listing;
in response to receiving the input selecting the program listing, displaying a second GUI used to play at least a portion of the respective video content item represented by the program listing, the second GUI including a linear status icon indicating the user's current playback point in the respective video content item;
receiving input via the second GUI to navigate to a third GUI; and
in response to receiving the input to navigate to the third GUI, displaying the program listing and an updated circular status icon, the updated circular status icon including a second highlighted arc indicating the user's current playback point in the video content relative to the entire duration of the video content, the updated circular status icon displayed to the left of text associated with the program listing.

2. The method of claim 1, wherein the first GUI is one of: an electronic program guide (EPG) interface, a “live now” content interface, a home interface.

3. The method of claim 1, wherein the first GUI, the second GUI, and the third GUI are separate interfaces of a media player application.

4. The method of claim 1, wherein each program listing representing the respective video content item available for playback by the user includes one or more of: a title of the respective video content item, a thumbnail associated with the respective video content item, a channel airing the respective video content item, and a summary of the respective video content item.

5. The method of claim 1, wherein the program listings include video content that has aired, video content that is currently airing, and video content that is airing in the future.

6. The method of claim 1, wherein the program listings include only video content that is currently airing.

7. The method of claim 1, wherein the video content item is one of: a television program, a movie, and a video on demand (VOD) content item.

8. The method of claim 1, wherein the video content is accessible from an internet-based television service.

9. The method of claim 1, wherein the circular status icon is displayed in response to receiving input indicating an input device hovering over the program listing.

10. The method of claim 1, wherein each program listing of the program listings includes a respective circular status icon overlaying the program listing.

11. The method of claim 1, wherein the entire duration of the respective video content is determined based on programming data indicating timing information for a plurality of video content items.

12. The method of claim 1, wherein the first highlighted arc is distinguished from the remainder of the status ring using one or more of: different colors for the status ring and the first highlighted arc, different line thicknesses for the status ring and the first highlighted arc, different line shadings for the status ring and the first highlighted arc.

13. The method of claim 1, wherein the circular status icon displays both the first highlighted arc and the second highlighted arc.

14. The method of claim 1, wherein the circular status icon displays the second highlighted arc and does not display the first highlighted arc.

15. The method of claim 1, wherein the third GUI includes at least one program listing overlaid with a circular status icon indicating an airing progress of respective video content and at least one program listing overlaid with a circular status icon indicating a user's playback progress of respective video content.

16. The method of claim 1, wherein the status ring encircles an icon reflective of a play status.

17. A computer-implemented method, comprising:
receiving input requesting display of a graphical user interface (GUI) associated with a plurality of video content items; and
in response to receiving the input, displaying the GUI including:
a plurality of non-overlapping images, each image being representative of a respective video content item of the plurality of video content items,
a first circular status icon overlaying a first image of the plurality of images, the first circular status icon including (a) a status ring forming a circumference of the first circular status icon and representing an entire playback duration of the respective video content item represented by the first image, and (b) a first highlighted arc of the status ring indicating a portion of the respective video content item represented by the first image that has aired relative to the entire duration of the respective video content item,
a second circular status icon overlaying a second image of the plurality of images, the second circular status icon including (a) a status ring forming a circumference of the second circular status icon and representing an entire playback duration of the respective video content item represented by the second image, and (b) a highlighted arc of the status ring indicating the user's playback point in the respective video content item relative to the entire duration of the respective video content item, and
wherein the first and second circular status icons look the same except that their respective highlighted arcs are different colors to represent different information about their respective video content items, wherein the respective video content item represented by the first image is currently airing and the user has not watched any part of it, and wherein at least part of the respective video content item represented by the second image has been watched by the user, the first and second circular status icons displayed to the right of text associated with their respective video content items.

18. The method of claim 17, wherein the GUI further comprises a third circular status icon overlaying a third image of the plurality of images, the third circular status icon including a status ring forming a circumference of the third circular status icon, the third circular status icon displayed without a highlighted arc to indicate that the respective video content item is not currently airing and no part thereof has been watched by the user.

19. A device, comprising:
one or more processors;
an input/output (I/O) interface to receive user input; and
a non-transitory computer-readable medium having stored therein instructions which, when executed by the one or more processors, causes the device to:
display a first graphical user interface (GUI) including:
a plurality of program listings, each program listing representing a respective video content item available for playback by a user, and
a non-linear status icon for a program listing of the plurality of program listings, the non-linear status icon including (a) a status element forming a perimeter of the non-linear status icon and representing an entire playback duration of video content represented by the program listing, and (b) a first highlighted portion of the status element indicating a portion of the respective video content represented by the program listing that has aired relative to the entire duration of the respective video content, the non-linear status icon displayed to the right of text associated with the program listing;
receive input selecting the program listing;
in response to receiving the input selecting the program listing, display a second GUI used to play at least a portion of the video content item represented by the program listing, the second GUI including a linear status icon indicating the user's current playback point in the respective video content item;
receive input via the second GUI to navigate to a third GUI displaying an updated program listing representing the video content item; and
in response to receiving the input to navigate to the third GUI, display the updated program listing and an updated non-linear status icon for the updated program listing, the updated non-linear status icon including a second highlighted portion indicating the user's current playback point in the video content relative to the entire duration of the video content, the updated non-linear status icon displayed to the left of text associated with the program listing.

20. A non-transitory computer-readable medium having stored therein instructions which, when executed by one or more processors of a computing device, causes the computing device to perform operations comprising:
displaying a first graphical user interface (GUI) including:
a plurality of program listings, each program listing representing a respective video content item available for playback by a user, and
a circular status icon for a program listing of the plurality of program listings, the circular status icon including (a) a status ring forming a circumference of the circular status icon and representing an entire playback duration of the respective video content item represented by the program listing, and (b) a first highlighted arc of the status ring indicating a portion of the respective video content represented by the program listing that has aired relative to the entire duration of the respective video content;
receiving input selecting the program listing;
in response to receiving the input selecting the program listing, displaying a second GUI used to play at least a portion of the respective video content item represented by the program listing, the second GUI including a linear status icon indicating the user's current playback point in the respective video content item;
receiving input via the second GUI to navigate to a third GUI; and
in response to receiving the input to navigate to the third GUI, displaying the program listing and an updated circular status icon, the updated circular status icon including a second highlighted arc indicating the user's current playback point in the video content relative to the entire duration of the video content.
